(19) United States
(12) Patent Application Publication
(10) Pub. No.: US 2003/0039727 A1
(43) Pub. Date: Feb. 27, 2003

(54) Meat chips

(76) Inventor: Selden G. Crocker, Kennebunk, ME (US)

Correspondence Address: WILLIAM F. HAMROCK, 50 WINTER HARBOR RD., KENNEBUNKPORT, ME, 04046, US

(21) Appl. No.: 10/217,783

(22) Filed: Aug. 13, 2002

Related U.S. Application Data
(60) Provisional application No. 60/311,770, filed on Aug. 13, 2001.

(51) Int. Cl. A23L 3/00

(52) U.S. Cl. 426/241

(57) ABSTRACT

Unique crisp pepperoni meat chips snack food is prepared having reduced calories, fat, and cholesterol. The process involves treating slices of pepperoni in a first “sweat” step, followed by a second “sweat” step and preabsorbent period where the pepperoni slices are enclosed within top double layers and bottom quadruple layers of absorbent material in a microwave tray. This is followed by a microwave treatment of the tray to transform the pepperoni slices into crispy pepperoni meat chips which are packaged in snack bags.

This application claims benefit under 35 USC 119(e) of Provisional Patent Application No. 60/311,770, filed Aug. 13, 2001.

### BACKGROUND OF THE INVENTION

The present invention relates to a unique crisp meat chip which has reduced calories, fat, and cholesterol and a process for making the meat chip. More specifically, the present invention relates to microwave processed pepperoni meat slices providing packaged pepperoni meat chips substantially reduced in calories, fat, and cholesterol and having a long shelf life.

Snack foods such as potato chips, taco chips, and various other food chips are very popular. The lightweight structure of the chips makes them desirable as a quick snack food. However, edible snack chips generally have high calories, fat, and cholesterol contents because of their manufacturing procedure which makes them undesirable as a snack food. Also, snack foods being high in fat content causes the food chips to have a shortened shelf life. Some microwave processes have involved treatment of snack foods containing meat, such as beef or pork, but these processes generally contain small bits of the meat mixed with other food products

U.S. Pat. No. 6,083,554 to Parker, for example, discloses a process of preparing a beef jerky—containing chips containing a grain product such as wheat, rice, or corn as well as bits of a meat product. Although pepperoni is cited in Col. 1, line 55, there is no disclosure of bits of pepperoni in the grain product.

U.S. Pat. No. 5,356,645 to Corbin discloses microwave puffable pork skin in a microwaveable container by steam cooking the pork skin, cooking in oil, and puffing the composition by microwave energy.

U.S. Pat. No. 3,520,701 to Rendek et al. discloses a microwave method of drying an emulsified comminuted meat, water, salt, and flavoring.

U.S. Pat. No. 3,512,993 to Conley et al. discloses a process for making a meat chip containing starch

No reference discloses a pure meat chip. All of these patents relate to meat or meat products in combination with a non-meat product to form a meat chip or meat product. There is a need for a crisp meat chip snack food which is not mixed with other food mixtures. There is a need for a crisp meat chip snack which has low calories, low fat, and low cholesterol and can be packaged in a small, hand-held snack package wherein the meat chips snacks have a long shelf life.

Sliced pepperoni is an extremely popular processed meat which is generally used in sandwiches or as a table food. However, pepperoni slices do not appear to be suitable as a packaged snack food probably because of its fatty surface texture due to its high fat content. Unfortunately, pepperoni is not only high in fat but also high in calories and cholesterol which makes it undesirable for snack food for health-conscious people. It would be advantageous to be able to process pepperoni slices into pepperoni chips which do not have the disadvantageous high calories, high fat, and high cholesterol content of the pepperoni slices. It would be further advantageous if these pepperoni chips would serve as a snack food, and could be prepared in small, snack food packages with a long shelf life. Applicant is not aware of any prior pepperoni prior art product that has been subjected to microwave energy to provide a crisp pepperoni chip free of other mixed food materials.

### SUMMARY OF THE INVENTION

In accordance with the present invention, it has been discovered that pepperoni slices can be treated by a process to provide pepperoni chips having only about one half the calories, fat, and cholesterol of the treated pepperoni slices while presenting a pleasing taste in chips having a crisp and crunchy texture. The process involves an initial “sweat” step of the slices of pepperoni in closed containers for a period of time, followed by a second “sweat” step and preabsorbent period wherein the slices of pepperoni are enclosed in absorbent material in trays for a period of time, and then followed by a microwave treatment step and major absorbent period of the absorbent covered pepperoni slices whereby the pepperoni slices are converted into crisp chips followed by a packaging step into plastic bags.

### BRIEF DESCRIPTION OF THE DRAWINGS

The objects and features of the invention will become apparent from the following description taken in conjunction with the preferred embodiment with reference to the accompanying drawings.

FIG. 1 illustrates slices of pepperoni in a covered vessel in a first “sweat” step.

FIG. 2 illustrates the slices of pepperoni in a second “sweat” step enclosed in absorbent material in a tray.

FIG. 3 illustrates the pepperoni being exposed to microwave energy.

FIG. 4 illustrates pepperoni chips drying on an air cooling rack.

### DETAILED DESCRIPTION OF THE PREFERRED EMBODIMENT

The invention is directed to preparing crisp pepperoni chips substantially reduced in calories, fat, and cholesterol which can be packaged in a snack bag and have a long shelf life. It provides health-conscious people with a healthy meat chip snack to be consumed as is or as a condiment or topping on their favorite foods,

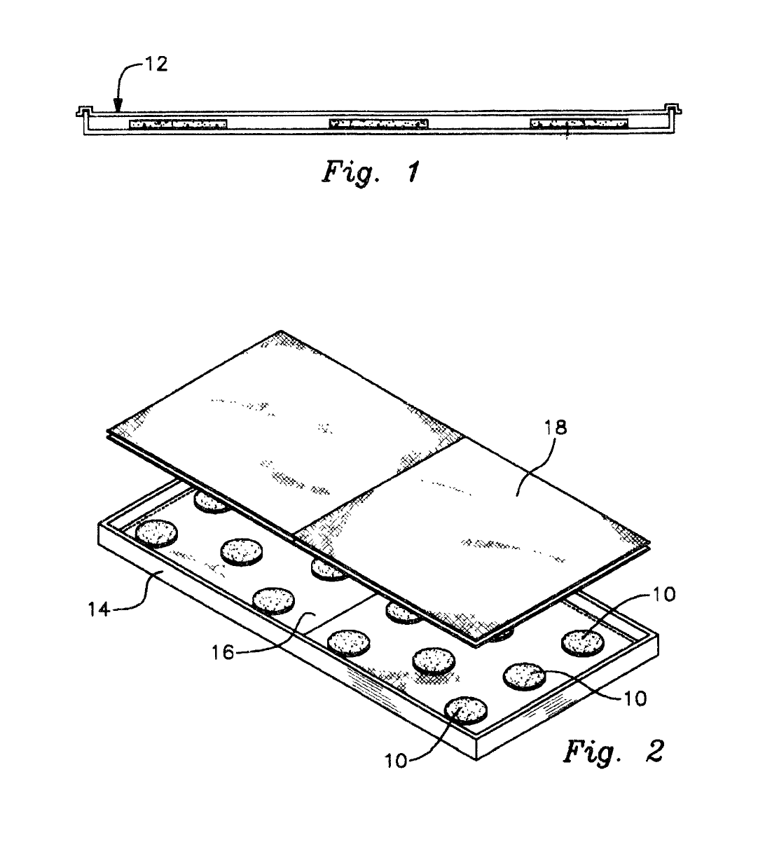

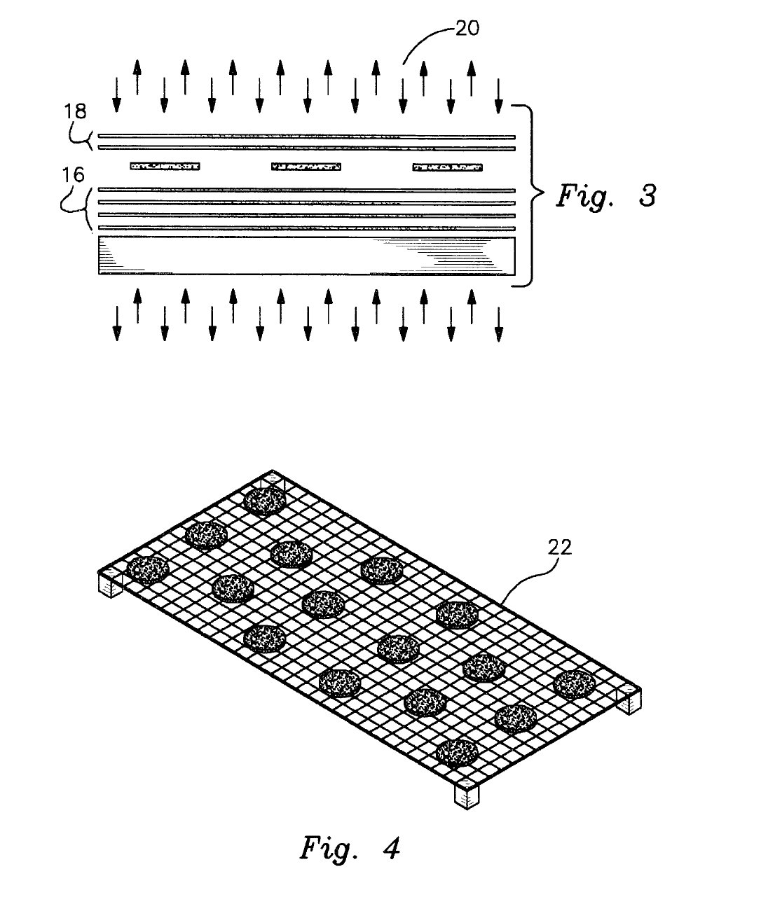

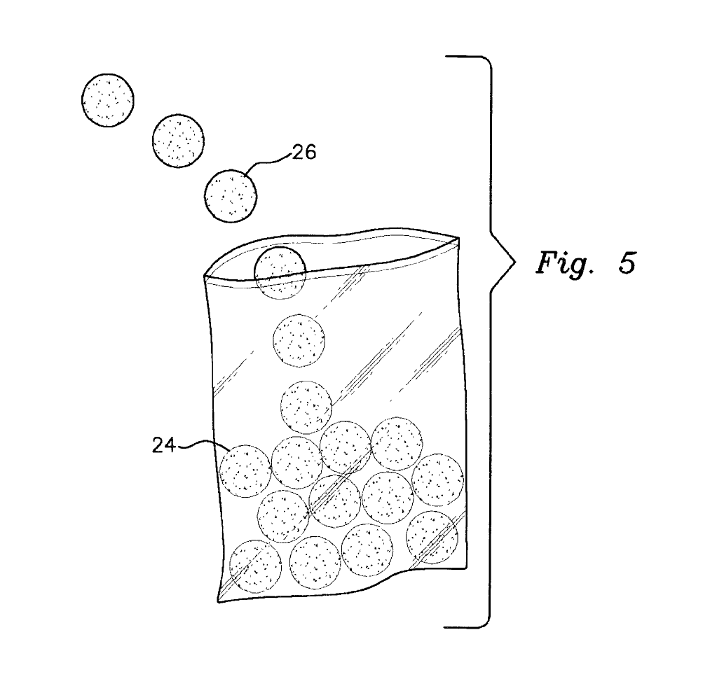

Initially, the pepperoni is cut into slices 10 about one sixteenth of an inch in thickness and stored in covered vessel 12 as seen in FIG. 1 although any type of a closed vessel can be used as long as the pepperoni slices are enclosed therein. During this first step, the pepperoni slices are allowed to “sweat” in the covered vessel at room temperature until the desired consistency of the slice is obtained, generally about one to four hours. Shown in FIG. 2, the individual slices are transferred to trays 14 and individually set on the top of four layers 16 of two-ply absorbent material covering the interior bottom of the trays. The bottom pepperoni containing trays are then covered with two layers of the same absorbent material 18 and the tray is stacked on top of previous trays, providing a second continued “sweating” step through a weighted process at room temperature resulting in increased absorption of excess moisture. When the desired second “sweat” step is completed, which runs between two to four hours, the gravitational pull downward of excess moisture of the pepperoni slices has been absorbed by the bottom four layers of absorbent material. Next, the trays are treated with microwave energy 20 as seen in FIG. 3 for about two minutes and twenty seconds with the final temperature reaching about 185 degrees Fahrenheit. During this time, the sliced pepperoni is heated rapidly, liquefying the harmful fats and oils, which are collected into the top and bottom absorbent layers of material.

When microwave treatment is completed, the top two layers of the absorbent material are removed and trays are transferred to a cooking station where the pepperoni chips 26 are removed from the bottom four layers of absorbent material and placed on cooling rack 22 wherein they are dried for about ten minutes. As shown in FIG. 4, the pepperoni chips are then packaged into small snack bags 24, preferably polypropylene plastic or similar plastic bags.

Due to the present processing technique of the important first and second steps to “sweat” the pepperoni slices, then the extremely important combination of double layers of absorbent material on the top and the quadruple layers of absorbent material on the bottom of the pepperoni slices which manage to equally absorb all the top and bottom absorbents of moisture and vaporized ingredients, next the rapid induction of microwave heat and immediate absorption of the liquefied fats and oils on the bottom and top layers of absorbent material; these steps provide unique pepperoni chips which have a crisp and crunchy texture with a new and different pleasant flavor over all previous meat containing chips as well as providing a healthier alternative of today's snack foods.

As the fats and oils are removed and adsorbed by the initial process steps and the microwave energy, the pepperoni slice is transformed into a crisp pepperoni chip maintaining all the protein but new enhanced flavor.

The following are the Reduction Statistics test results for sixteen treated pepperoni slices and pepperoni chips of the invention:

REDUCTION STATISTICS

| | | | | |
|---|---|---|---|---|
| Pepperoni - 16 slices | (28 | g) | before processing | |
| | (14 | g) | after processing | |
| Calories | 130 | | before | 46% reduction |
| | 71 | | after | |
| Calories from fat | 110 | | before | 62% reduction |
| | 42 | | after | |
| Total fat | 12 | g | before | 62% reduction |
| | 4.64 | g | after | |
| Saturated fat | 4 | g | before | 65% reduction |
| | 1.40 | g | after | |
| Cholesterol | 25 | mg | before | 56% reduction |
| | 11 | mg | after | |

The following are the laboratory test results by Northeast Laboratory Services, of Winslow, Me. of the sample crisp pepperoni chips of the invention:

| | Result per | | Result per ½ |
|---|---|---|---|
| Parameter | 100 grams | | Oz. (14 grams) |
| Protein | 49.87 | g | 6.98 |
| Fat | 33.12 | g | 4.64 |
| Saturated Fat | 10.00 | g | 1.40 |
| Cholesterol | 82 | mg | 11 |
| Carbohydrate | 2.32 | g | 0.32 |
| Sodium | 4000 | mg | 560 |
| Moisture | 2.12 | g | 0.30 |
| Ash | 12.57 | g | 1.76 |
| Calories | 507 | | 71 |
| Calories from Fat | 298 | | 42 |

What is claimed is:

1. A process for making crisp pepperoni meat chips having reduced calories, fat and cholesterol comprising
subjecting pepperoni slices to a first “sweat” step in a closed container at room temperature,
subjecting the sweated pepperoni slices enclosed within top and bottom layers of absorbent material in an open top microwave tray to a second “sweat” step and a preabsorbent step at room temperature,
subjecting the absorbent material enclosed pepperoni slices in the tray to microwave energy for a period of time forming pepperoni chips.

2. The process according to claim 1 wherein the microwave energy temperature reaches about 185 degrees F.

3. The process according to claim 2 wherein the pepperoni slices in the tray are subjected to microwave energy for about two minutes and twenty seconds.

4. The process of claim 1 wherein double layers of absorbent material comprise the top layers and quadruple layers of absorbent material comprise the bottom layers in the tray.

5. The process according to claim 1 wherein the pepperoni slices are about one sixteenth of an inch in thickness.

6. The process according to claim 5 wherein sixteen pepperoni slices weigh about twenty eight grams.

7. The process according to claim 6 wherein sixteen pepperoni chips weighs about fourteen grams.

8. The process according to claim 7 wherein sixteen pepperoni slices comprise about 130 calories, about 12 grams of fat and about 25 mg of cholesterol.

9. The process according to claim 8 wherein sixteen chips comprise about 71 calories, about 4.64 grams of fat and about 11 mg cholesterol.

10. The process according to claim 1 wherein the chips are packaged in a small snack bag.

11. The process according to claim 1 wherein the first “sweat” step is for about one to four hours.

12. The process according to claim 1 wherein the second “sweat” step is for about two to four hours

13. Sixteen crisp pepperoni meat chips weighing about fourteen grams comprising about 71 calories, about 42 calories from fat, about 4.64 grams of fat, about 1.40 saturated fat and about 11 grams of cholesterol.

14. Crispy pepperoni meat chips in a microwave tray having reduced calories, fat and cholesterol prepared by a process comprising
subjecting pepperoni slices to a first “sweat” step in a closed container at room temperature,
subjecting the sweated pepperoni slices enclosed within top and bottom layers of absorbent material in an open top microwave tray to a second “sweat” step and a preabsorbent step at room temperature,
subjecting the absorbent material enclosed pepperoni slices in the tray to microwave energy for a period of time forming pepperoni chips.

15. The crispy pepperoni meat chips according to claim 14 wherein sixteen pepperoni meat slices weigh about 28 grams and sixteen pepperoni meat chips weigh about 14 grams.

16. The crisp pepperoni meat chips according to claim 15 packaged in a small snack bag.
